(19) United States
(12) Patent Application Publication
(10) Pub. No.: US 2015/0359304 A1
(43) Pub. Date: Dec. 17, 2015

(54) PANEL BRACELET WITH INSERTED PANELS

(71) Applicant: Michael Thomas, Centerbrook, CT (US)

(72) Inventor: Michael Thomas, Centerbrook, CT (US)

(21) Appl. No.: 14/742,379

(22) Filed: Jun. 17, 2015

Related U.S. Application Data
(60) Provisional application No. 62/013,256, filed on Jun. 17, 2014.

(51) Int. Cl. A44C 17/02; G04G 17/00; A44C 5/00

(52) U.S. Cl. CPC A44C 17/0208; A44C 5/0053; A44C 5/0007; A44C 5/003; A44C 5/0015; G04G 17/00

(57) ABSTRACT

A reversible bracelet includes a series of open insert or panel holding frames, wherein each frame holds a two sided panel therein with each side of the panel including an ornamental design. Each frame may be rubber or silicon or similar materials and maybe i) generally “C” shaped in cross section to receive and retain one panel therein, or ii) includes a retaining bead received within a matching groove in the associated panel to receive and retain the panel therein. The panels may be press fit into the frame. Each frame/panel may be pivoted relative to the adjacent frame/panel to provide selective reversibility to the bracelet or the bracelet may be flipped in its entirety. The panels may be formed of two separate facing halves coupled together and may be designed by the user's themselves in an on-line panel creation system.

### RELATED APPLICATIONS

The present application claims the benefit of Provisional Patent application Ser. No. 62/013,256 filed on Jun. 17, 2014 and entitled “Reversible Panel Bracelet with Two Sided Inserted Panels” which is incorporated herein by reference.

### BACKGROUND OF THE INVENTION

1. Field of the Invention

The present invention relates to jewelry, specifically to a panel bracelet with inserted panels.

2. Background Information

The word “jewelry” is derived from the Latin word jocale, meaning “plaything,” and the word jewel, which was anglicized during the 13th century from the Old French word “jouel.” The word “jewelry” (spelled jewellery in European English) is used to describe any piece of precious material (gemstones, noble metals, etc.) used to adorn one's self. Jewelry has played a constant and significant part of human history.

Throughout human history, irrespective of religion, race, or culture, jewelry has existed as an integral form of expression, wealth and social status. While the materials and techniques used to manufacture jewelry have in many ways evolved, there are also a number of similarities with the very first forms of jewelry worn, according to some estimates, an astounding 75,000 to 100,000 years ago. Relatively recently discovered mollusk or nassarius kraussianus shells that had been perforated to be strung together are now thought to be some of the oldest known man-made jewelry. This mollusk jewelry was discovered in a cave in Blombos, South Africa, and dates back to the Middle Stone Age, some 75,000 to 100,000 years ago. In the late 1800s, British archaeologist Archibald Campbell Carlyle said of primitive man that “the first spiritual want of a barbarous man is decoration.” More than just a curio from the past, jewelry, like art, is a window into the soul of humanity, and a poignant reminder of that which separates humankind from the animal kingdom—a desire to capture the essence of beauty, to posses its secrets, and to unlock its mysteries.

Bracelets are a type of jewelry worn around the wrist, and less commonly around the ankle (although this subset of jewelry is technically “anklets”), of the user and themselves have a long and storied history. Many scholars cite that the earliest known bracelets hark back to 2500 BC, worn by the ancient Sumerians of Southern Mesopotamia. Other sources suggest that “bracelets first worn in 4700 BC during the reign of King Zer were constructed from gold and manufactured in a style widely available today.” Clearly, bracelets were worn long before the even term bracelet was established. Dr. Mark Clayson has described that “during ancient Grecian times, soldiers wore defensive bands of leather often decorated with gold, silver, and other gemstones on their forearms called Bracels, from the Latin term for arm, “Brachium”. The Grecian women realized that these accessories would look good on them, so they began wearing smaller versions—called Bracel-ets.”

One type of common bracelet may be called a panel bracelet and is one utilizing a series of decorative panels coupled along the bracelet. FIG. 1 illustrates what has been called an antique panel bracelet 10 and includes a series of rectangular frames 12 holding individual decorative porcelain or ivory panels 14. The frames 12 are also called bezels or mounts and may be pivotally coupled together through links or a hinge such as shown in FIG. 1.

A conventional clasp or connection may be provided on the respective ends of the bracelet 10 to allow the bracelet 10 to be coupled around the wrist of the user. Other bracelet designs are a continuous hoop which is slipped over the user's wrist, and these may also incorporate a clasp that acts to shorten the hoop to secure the bracelet in place (such as found in many wrist watch designs).

FIG. 2 illustrates a panel bracelet from the 1980s which attaches two distinct decorative Lucite panels 14 on opposed sides of each gold plated frame 12. This design allows the user to selectively reverse the bracelet 10 as desired, to give the user greater flexibility in the appearance of the bracelet 10 and thus greater utility in the bracelet 10.

FIG. 3 illustrates a known panel bracelet 10 design that is called an Italian modular charm bracelet, such as available at www.italiancharms.com. This panel bracelet 10 uses stainless steel rectangular link frames 12 to which are coupled decorative panels 14, called “Charms” formed of decorative enamel, cubic zirconia, and natural or faux stones. The frames 12 and associated charms or panels 14 are intended to be easily and quickly interchangeable by the wearer. Further, the variety of available “charms” or panels 14 allows the user to build their own bracelet 10 and the developers have incorporated an on-line simulation to allow the user to see how their custom bracelet 10 design will look to aid in its design.

FIG. 4 illustrates a known panel bracelet 10 design that is called a “boozy wisdom” bracelet. In this bracelet 10 the panels 14 are essentially integral with the frame 12 to provide a reversible bracelet 10 which is comprised of four panels 14, each inscribed on either side with a variety of cheeky phrases, such as “Good form, but not formality” alongside an image of a shapely woman, and a tiny beer stein decorates a panel that reads To our wives and sweethearts, may they never meet” As with the panel bracelet 10 of FIG. 2 this design allows the user to selectively reverse the bracelet 10 as desired, to give the user greater flexibility in the appearance of the bracelet 10 and thus greater utility in the bracelet 10.

FIG. 5 illustrates an antique panel bracelet 10 from the 1930's and includes a series of rectangular filigree frames 12 holding individual decorative panels 14. The panels 14 in this bracelet 10 are bone and referenced as storyteller scrimshaw. Scrimshaw itself has its own fascinating history.

FIG. 6 illustrates an antique panel bracelet 10 called a memory frame bracelet with nickel plated frames 12 receiving images, such as sepia 19th Century female transfers, forming panels 14 within the meaning of this application.

The patent literature also discloses a number of bracelet developments, such as U.S. Pat. Nos. 7,036,339 and 6,629,434 which are incorporated herein by reference and disclose a decorative jewelry module that comprises a base member with a hollow interior, a decorative insert, and a fastener arrangement. The decorative insert is sized in relation to the interior of the base member so as to be placed within the hollow base member and viewed through the top opening and wherein number of such units may be connected in series to form a tennis bracelet.

U.S. Pat. No. 4,862,435, which is incorporated herein by reference, discloses a combination bracelet and wristwatch.

U.S. Pat. No. 7,409,837, which is incorporated herein by reference, discloses an interchangeable jewelry insert having an extension formed of elastic material that can frictionally engage a surface of a receptacle for receiving the insert.

U.S. Pat. No. 8,371,141, which is incorporated herein by reference, discloses jewelry which includes a decorative insert body and a receiving portion that includes an opening for receiving the decorative insert body. For example, the decorative insert body may include magnetic material and the receiving portion includes a rear portion including ferromagnetic material.

U.S. Pat. No. 6,571,578, which is incorporated herein by reference, discloses a reversible ornamental article of jewelry having a plurality of ornamental links hinge ably secured to one another to form a flexible strand of jewelry, which can be in the form of a necklace or bracelet.

U.S. Patent Application Publication Number 2010-0300146, which is incorporated herein by reference, discloses a decorative charm that is designed to reversibly attach to an elastic band wherein the design of the decorative item described herein that facilitates its reversible attachment to an elastic band or bracelet.

Bracelets form an ongoing important part of the story of humanity and there is an ongoing desire to give individuals new tools for expressing their desire for ornamentation. Improvements in panel bracelet design further these desires.

### SUMMARY OF THE INVENTION

Some of the objects of the invention are achieved with a flexible reversible bracelet with inserted two sided panels according to the present invention.

One embodiment of the invention provides a reversible bracelet with inserted two sided panels formed of a series of open insert or panel holding frames, wherein each frame is designed to hold a two sided panel therein with each side of the panel including an ornamental design. Each open frame may be formed of a rubber or silicon or similar materials and generally “C” shaped in cross section to receive and retain one of the two sided panels therein, which may be snap or press fit into the frame. Each frame/panel may be pivoted relative to the adjacent frame/panel to provide selective reversibility to the bracelet or the bracelet may be flipped in its entirety. The panels may be formed of two separate facing halves coupled together and may be designed by the user's themselves in an on-line panel creation system. The panels may have sports motifs, may be formed as watches, key-holding units, electronic devices, sports trading cards, convertible to toys, etc.

One embodiment of the present invention provides a panel bracelet comprising an elastomeric body having two rectangular panel holding frames, wherein each frame is designed to hold a panel therein wherein each panel holding frame is i) generally “C” shaped in cross section to receive and retain one of the panels therein and which are press fit into the frame, or ii) includes a retaining bead that is received within a matching groove in the associated panel to receive and retain one of the panels therein and which are press fit into the frame, and a plurality of panels associated with the panel bracelet and removeably secured within the rectangular panel holding frames.

These and other advantages of the present invention will be clarified in the brief description of the preferred embodiment taken together with the drawings in which like reference numerals represent like elements throughout.

### BRIEF DESCRIPTION OF THE DRAWINGS

FIGS. 1-6 illustrate prior art panel bracelet designs;

FIG. 7A is a perspective schematic view of a reversible bracelet with inserted panels according to one aspect of the present invention;

FIG. 7B is a top plan view of the reversible bracelet with inserted panels according to FIG. 7A with the panels removed and four replaceable panels shown adjacent thereto;

FIG. 8A is a perspective schematic view of a reversible bracelet with inserted panels according to one aspect of the present invention;

FIGS. 8B and C are side elevation views of the reversible bracelet with inserted panels according to FIG. 8A with the panels removed and four replaceable panels shown adjacent thereto;

FIG. 8D is a top plan view of a reversible bracelet with inserted panels according to FIG. 8A with the panels removed and four replaceable panels shown adjacent thereto;

FIGS. 8E and F are side elevation views of the reversible bracelet with inserted panels according to FIG. 8A with the panels removed and four replaceable panels shown adjacent thereto;

FIG. 9 is a sectional schematic elevation view of a panel holding frame and panel of the bracelet according to FIG. 7A;

FIG. 10 is a schematic side elevation view of a panel of the bracelet according to FIG. 7A;

FIG. 11 A is a perspective schematic view of a bracelet with inserted http://www.software995.com/panels according to one aspect of the present invention;

FIG. 11 B is an exploded perspective schematic view of a bracelet with inserted panels of FIG. 11 A;

FIG. 12A is a perspective schematic view of a bracelet with inserted panels according to one aspect of the present invention;

FIG. 12B is an exploded perspective schematic view of a bracelet with inserted panels of FIG. 12A;

FIG. 13 is a perspective schematic view of a bracelet body having two panel holding frames for forming the bracelet with inserted panels of FIGS. 11A and 12A;

FIG. 14 is a perspective schematic view of a panel for use with the bracelet with inserted panels of FIG. 11 A;

FIG. 15A is a perspective schematic view of a panel for use with the bracelet with inserted panels of FIG. 12A;

FIG. 15B is a perspective schematic view of a panel cover for use with the bracelet with inserted panels of FIG. 12A;

FIG. 16 is a perspective schematic view of an adaptor or extender for selective use with the bracelet with inserted panels of FIGS. 11 A and 12A;

FIGS. 17A-H are perspective schematic views of alternative utilitarian panels for the bracelet use with the bracelet with inserted panels of FIGS. 11A and 12A.

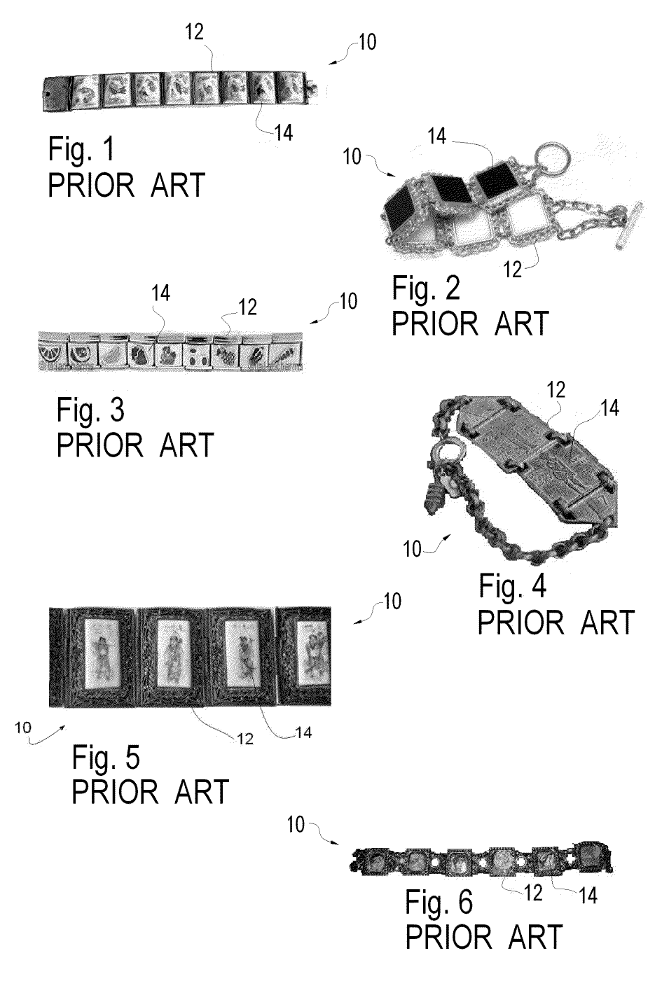

### DESCRIPTION OF THE PREFERRED EMBODIMENTS

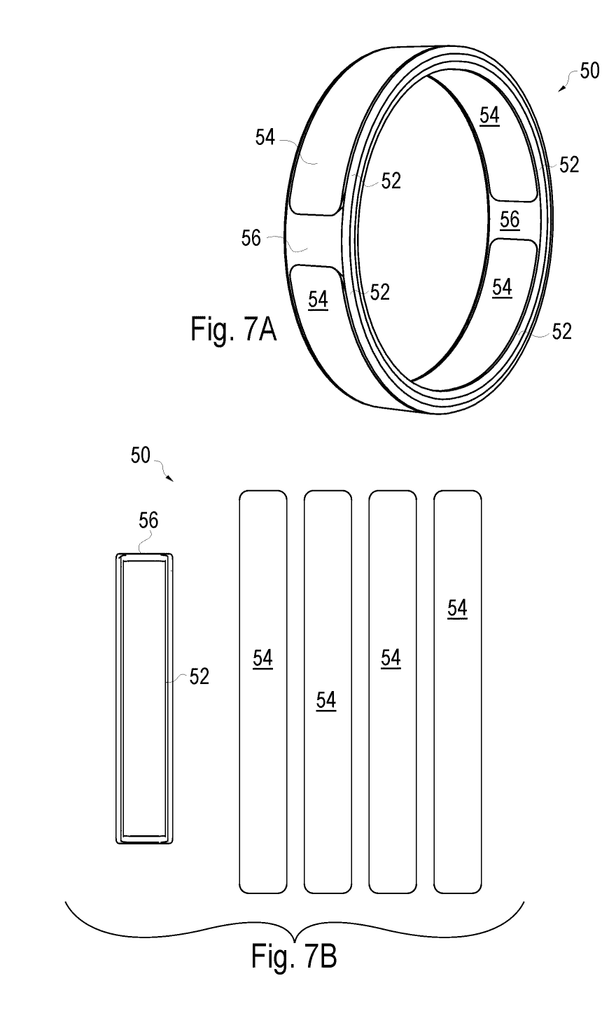

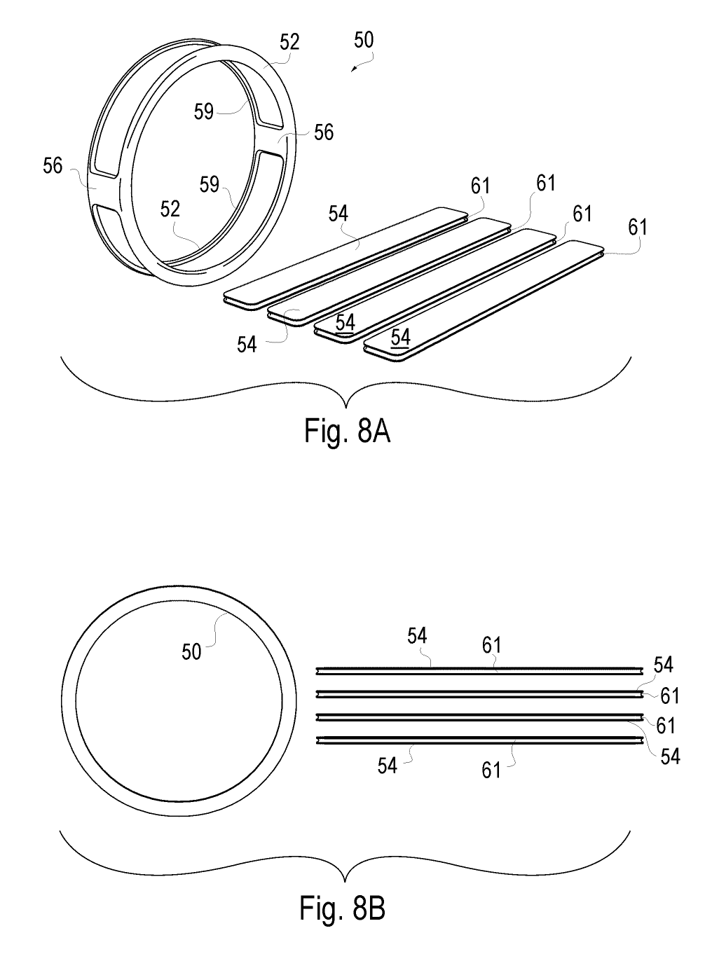

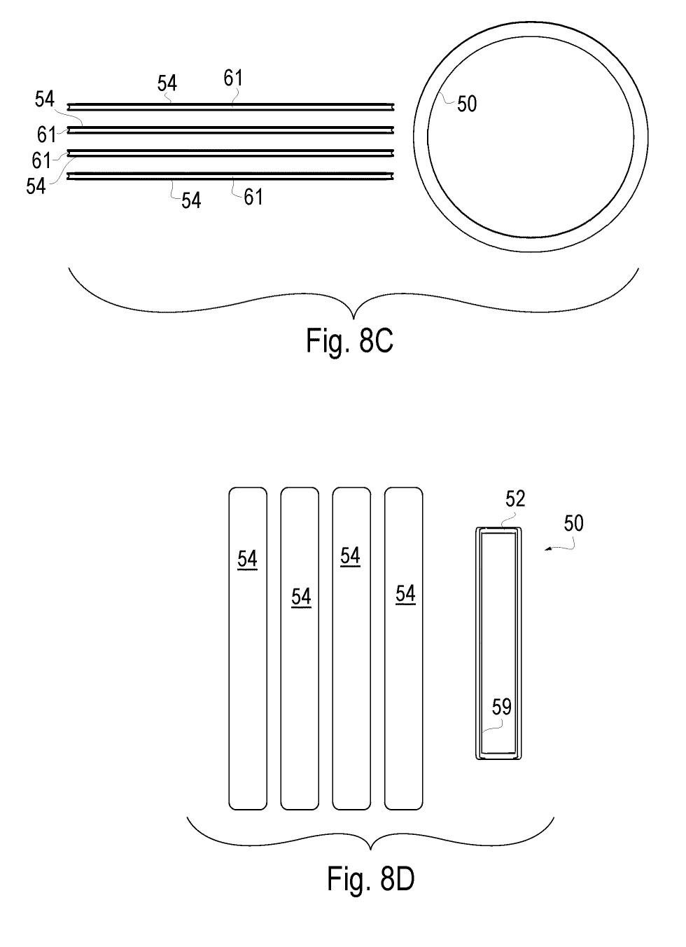

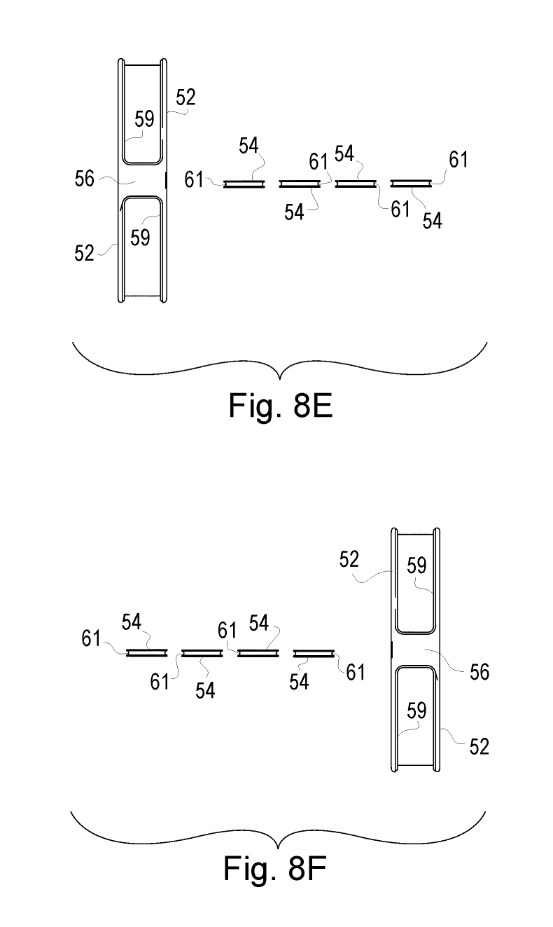

FIG. 7A is a perspective schematic view of a reversible bracelet 50 formed of a series of open panel holding frames 52, wherein each frame 52 is designed to hold a two sided panel 54 therein according to one aspect of the present invention. FIG. 7B is a top plan view of the reversible bracelet 50 with inserted panels 54 according to FIG. 7A with the panels 54 removed therefrom and four replaceable panels 54 shown adjacent thereto. FIG. 8A is a perspective schematic view of a reversible bracelet 50 with inserted panels 54 according to another aspect of the present invention. FIGS. 8B and C are side elevation views of the reversible bracelet 50 with inserted panels 54 according to FIG. 8A with the panels 54 removed there-from and four replaceable panels 54 shown adjacent thereto.

The bracelet 50 may be formed of any desired material as known above from the prior panel bracelets 10 and those described in the patent literature. However it may be advantageous and efficient to form the bracelet 50, and possibly the panels 54, from an elastic material such as silicon or rubber or the like. The use of elastic material allows the bracelet 50 to be formed of a continuous loop as shown, possibly by molding or extruding, with elastic members 56 coupling the frames 52. Alternatively for non loop constructions, any of a number of clasps may be utilized as known in the art.

Regarding the number of open frames 52, as with frames 12 of the prior art designs, a wide number of frames 52 may be implemented into the bracelet 50. The number of frames 52 is dictated by the length of the bracelet 50 and the size of the individual panels 54. Two panel holding frames 52 and associated panels 54 are shown in the embodiments of FIGS. 7A-B and FIGS. 8A-F merely for illustration.

The general peripheral shape of the panel holding frames 52 is dictated by the shape of the individual panels 54 (which may also be called charms). The peripheral shape shown is rectangular, but other shapes such as ovals, circular, square, ellipses, triangles, pentagons, hexagons and combinations thereof may be used. It is the desired peripheral shape of the panels 54 or charms that dictate the shape of the associated frames 52. Further, a single bracelet may have distinct shaped frames 52 and panels 54 therein. The use of long rectangle panels 54 and frames 52, as shown, do require a level of flexibility in both the frame 52 and the panels 54 to accommodate the reversibility. Smaller panel sizes would allow more rigid panels 54 to be utilized.

As noted the bracelet 50 is formed of a series of open insert or panel holding frames 52, wherein each frame 52 is designed to hold a two sided panel 54 therein with each side of the panel 54 including an ornamental design. The specifics of the ornamental design or limitless and can include any design as suggested above in connection with numerous panels 14.

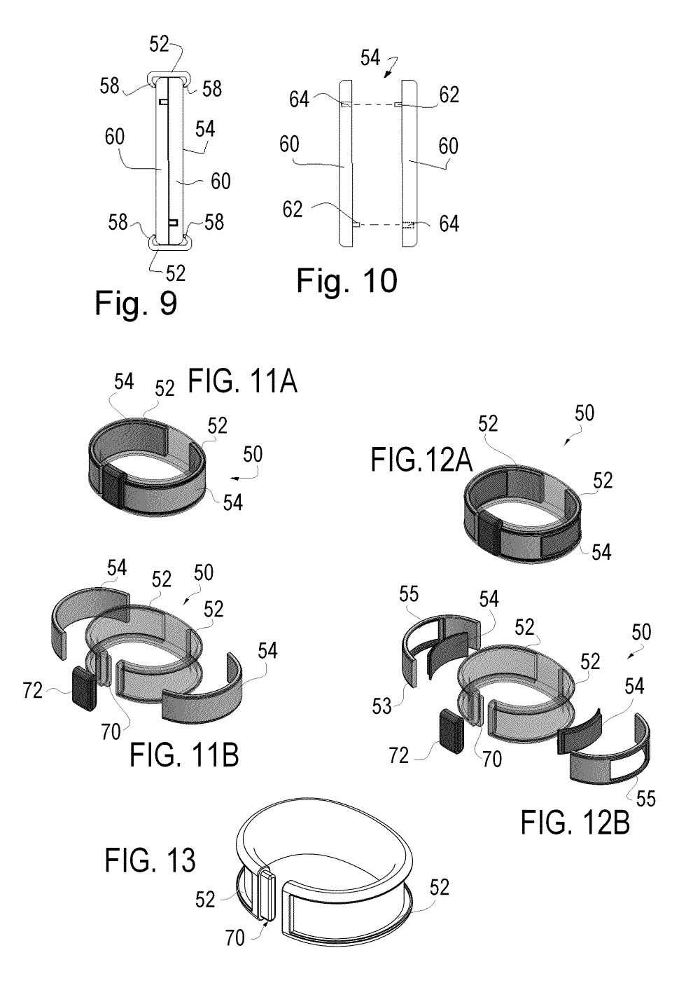

As noted above, each open frame 52 may be formed of a rubber or silicon or similar materials. FIGS. 7A and 7B and 9 have the frame shaped as generally “C” shaped in cross section having arms or extensions 58 as shown in sectional view of FIG. 9 so as to receive and retain one of the two sided panels 54 therein, which may thus be snap or press fit into the frame 52. Where a more rigid material forms the frame 52, then a flexible panel 54 may be used in a similar manner. The flexible materials disclosed can also have a relatively high co-efficient of friction to more securely hold the panels 54.

FIGS. 8A-F have the frame 52 shaped with a retaining bead 59 that is received within a matching groove 61 in the associated panels 54 as shown. In this embodiment the frames 52 with bead 59 also receive and retain one of the two sided panels 54 therein, which may thus be snap or press fit into the frame 52 with the bead 59 engaging the groove 61 of the panel 54. Alternative snap fit couplings may also be implemented.

Alternatively, if rigid materials are desired to be used for both the open frame 52 and the panel 54 then the frame 52 can include a removable side that can allow the panel to slide into place and then have the removed side reattached and secured. Such alternative construction is believed to be within the general knowledge of the jewelry art.

The flexible construction of the bracelet 50 described allows reversibility to be accomplished by having the bracelet 50 flipped in its entirety (i.e. turned inside out). As an alternative to the closed loop design as shown, each frame 52 may be coupled to adjacent frames 52 via a swivel so as to be pivoted relative to the adjacent frame 52 to provide selective reversibility to each respective panel of the bracelet 50.

FIG. 10 illustrates a construction in which a panel 54 is formed of two separate facing halves 60 that may be coupled together. Snap fit projection 62 and receiving hole 64 could form the coupling mechanism. The use of one projection 62 and one hole 64 on each half 60 allows the halves to be formed universally allowing the user to couple any two desired halves 60 (rather than forming left and right or male and female parts that limits the combinations). The snap fit design of halves 60 may be easily molded by injection molding with decorative designs added later (via silkscreen printing, or decal or the like). As an alternative magnets on the back of each half 60 could be used for coupling two halves 60 to form a single panel 54.

It is contemplated that the users may wish to leave selective frames empty to give a more open bracelet design. Further it is contemplated that the panels 54 (or panel halves 60) may be designed by the user's themselves in an on-line panel creation system. The panels 54 (or panel halves 60) may have sports motifs or really essentially any theme one can imagine. The panels 54 (or panel halves 60) may be formed as watches, key-holding units, electronic devices (e.g., pulse measuring/recording/transmitting device, temperature measuring/recording/transmitting device), sports or other trading cards, panels that are convertible to toys, Photos (family photos), Mirror, Glow in the dark inserts, etc.

The snap fit panel holding frames 52 can be expanded beyond bracelet construction as shown. The same construction of frame and inserted double faced panel 52 may be easily utilized as a necklace, or as a broach or earring. Outside of the jewelry art, the frame 52 may be used as, in larger form, a simple picture frame as well.

FIG. 11A is a perspective schematic view of a bracelet 50 with inserted panels 54 according to one aspect of the present invention and FIG. 11 B is an exploded perspective schematic view thereof. Similarly FIG. 12A is a perspective schematic view of a bracelet 50 with inserted panels 54 according to one aspect of the present invention and FIG. 12B is an exploded perspective schematic view of this bracelet 50. FIG. 13 is a perspective schematic view of a common bracelet body having two panel holding frames 52 for forming the bracelet 50 with inserted panels 54 of FIGS. 11 A and 12A.

The bracelet of FIGS. 11 A and 12A are similar to those described above in connection with FIGS. 7 and 8. Here the body of the bracelet 50, and some of the panels 54, are formed from an elastic material such as silicon or rubber or the like. The use of elastic material allows the bracelet 50 to easy to reverse, assuming the specific inserted panels 54 accommodate the reversal. The body of the bracelet as shown is formed clear or semi transparent such that the panel holding frames 52 may have a backing on one side, such that the reverse side of the two sided panel will be seen through the clear or semi-transparent back. Here the two panel holding frames 52 and associated panels 54 are shown in the embodiments of FIGS. 11A-B and FIGS. 12A-B as two is preferred in this embodiment.

The general peripheral shape of the panel holding frames 52 for the embodiments of FIGS. 11 A-B and FIGS. 12A-B is preferably rectangular, as shown. The snap-fit panel and frame construction discussed above is preferred. The frames 52 of FIGS. 11A-B and 12-A-B have the frame shaped as generally “C” shaped in cross section having arms or extensions (as shown in sectional view of FIG. 9 so as to receive and retain one of the two sided panels 54 therein), which may thus be snap or press fit into the frame 52. As noted above the flexible materials disclosed can also have a relatively high co-efficient of friction to more securely hold the panels 54.

The bracelet 50 of FIGS. 11A-B and 12A-B further includes the use of a snap fit male-female clasp 70 for easily opening and closing the bracelet 50 for placing on the user. An adaptor or extender 72, shown individually in FIG. 16, allows the bracelet 50 to accommodate a variety of sized, and the use of more than one extender, or extenders of various lengths are also contemplated.

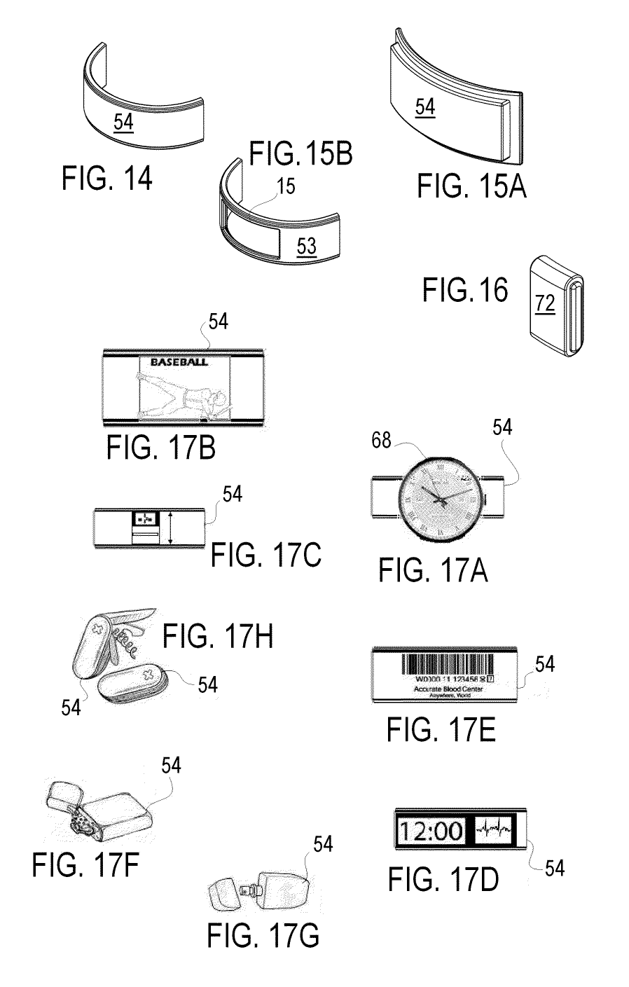

The bracelets 50 of FIGS. 11 A-B and 12A-B both use a common body shown in FIG. 13 but differ in the sized panels 54 that are used. The bracelets 50 of FIGS. 11A-B uses arcuate panels 54 filling the frame 52 and these are shown in FIG. 14. The bracelets 50 of FIGS. 11A-B uses arcuate panels 54 that may be shorter than the frame 52 and these are shown in FIG. 15A. The bracelets 50 of FIGS. 11A-B further uses a panel cover 53 having an insert window 55 for use with the bracelet with inserted panels of FIG. 12A. The panel cover 53 will snap onto the body of bracelet 50 similer to the panel 54 and can be used to further lock the insert 54 in place. Further the insert may extend into the window 55 of the cover 53. The cover 53 and the body of the bracelet combine to sandwich the insert therebetween and allow for greater securing of the insert. Further distinct covers 53 can be adapted for distinct panels 54 to increase the size and types of inserts that may be associated with a given band

FIGS. 17A-H demonstrate that the panels 54 may include a variety of utilitarian aspects aside from mere decoration. For example the panels may include electronic components such as watches, as shown in FIG. 17A, and such a panel 54 may have a portion 68 of the panel 54 extends beyond the frame 52 to give more versatility to the desired panels 52. Care must be taken when designing portions 68 that extend beyond the frame 52 that the portion 68 does not interfere substantially with either to connection between the panel 54 and frame 52 or the reversibility of the bracelet 50.

As discussed above the panels may be in the form of a collectable element, namely a sports card or gaming card as shown in FIG. 17B.

FIG. 17C schematically illustrates the inclusion of a USB key (also called a memory stick) incorporated into a panel 54. In use the panel can be popped out of the frame 12 and the USB engaging member slid laterally out of the side edge of the panel 54 and the memory stick installed in a USB port of a computer. The function and structure of a USB member, and the slide mechanism therefore, is known in the art. In this configuration a whole in the side of the bracelet body allowing the USB member to slide through would allow the panel 54 to be used without removing it from the frame 52. Alternatively a flip up engagement member may be utilized.

FIG. 17D schematically illustrates the inclusion of electronic sensors and user display incorporated into a panel 54, which track user biosignals (pulse rate, breath rate and the like). This can be useful for monitoring a users activity during the day or during specific exercise periods and these may communicate with other devices, such as with a users health related application on a smart phone (e.g. a MAPMYRUN® exercise tracking application) or with an exercise machine (treadmill). Further details of the use and application of this type of sensors in this panel 54 are found in reviewing the FITBIT® brand trackers.

FIG. 17E schematically illustrates the inclusion of a barcode or other optical scanned code incorporated into a panel 54. The barcode in this panel 54 will typically be a user identification bar code such as a hospital user ID band or a gym membership identification. Both the gym membership and the hospital ID band ID panels 54 applications for this panel 54 may be particularly well suited to be paired with the biometric sensor panels of FIG. 17D.

In the hospital application the patient may be given a bracelet 50 with a personal ID panel 54 as shown in FIG. 17E, which panel 54 is made up for the specific patient (e.g. a label with barcode ID is created and attached to a blank panel 54), and the other panel 54 of bracelet 50 includes desired biometric sensors such as discussed in connection with FIG. 17D wherein the patient's heart rate, ekg, breath rate or the like may be measured with an appropriate panel 54 discussed in association with FIG. 17D and tied to the patient associated with the ID panel 54 of FIG. 17E.

In a gym membership example the member may be given a bracelet 50 with a personal membership ID panel 54 as shown in FIG. 17E, which panel 54 is made up for the specific member (e.g. a label with barcode ID is created and attached to a blank panel 54), and the other panel 54 of bracelet 50 includes desired exercise biometric sensors discussed in connection with FIG. 17D. When entering the gym the user can scan the ID to gain access and to have the specific exercises and results of the member measured and associated with that member (via particular machines or exercise classes or the like). The gym, the member and/or personal trainers can utilize the information to more precisely direct the member's workouts to maximize the effects. The bracelet 50 becomes more than a gym access device and a tool to facilitate the goals of the individual and the gym. Different sensing via distinct panels 54 or different analysis of the data may be made available at different costs and or different membership levels to give the gym some greater monetization opportunities.

FIG. 17F schematically illustrates the inclusion of a lighter incorporated into a panel 54, while FIG. 17H schematically illustrates the inclusion of a series of tools into a panel 54 (e.g. in the manner of a Swiss army knife). These panels 54 may be combined to form a desired utilitarian bracelet, i.e. a camper's bracelet.

FIG. 17G schematically illustrates the inclusion of a pump spray container incorporated into a panel 54. This panel 54 may be sufficient to hold a desired amount of women's perfume or men's cologne. Any fluid that a user may desire to have a periodic but immediate use of could be used, such as breath spray (for dating), bug spray (for camping), sun screen (for any outdoor activity), medicaments (e.g. Albuterol, a bronchodilator, for patients).

Other utilities for panels 54 include the functions of a cell phone, such as camera, flashlight, recorder, transmitter, and other phone functions. Other configurations include safety lights (for pedestrians and/or bicyclists) in panels 54; or Pens, Pencils, Highlighter in a panel 54 (e.g. for golfers); glow in the dark elements in a panel 54 (great for nighttime concerts or amusement parks patrons); and a number of other items. The bracelet 50 gives a useful platform for a multitude of applications with designated panels 54.

The scope of the invention is not to be limited by the illustrative examples described above. The scope of the present invention is defined by the appended claims and equivalents thereto.

What is claimed is:

1. A reversible panel bracelet with inserted two sided panels formed of a series of open panel holding frames, wherein each frame is designed to hold a two sided panel therein with each side of the panel including an ornamental design, wherein each panel holding frame is i) generally “C” shaped in cross section to receive and retain one of the two sided panels therein and which are press fit into the frame, or ii) includes a retaining bead that is received within a matching groove in the associated panels to receive and retain one of the two sided panels therein and which are press fit into the frame.

2. The reversible panel bracelet with inserted two sided panels according to claim 1 wherein each panel holding frames may be pivoted relative to the adjacent panel holding frames to provide selective reversibility to the bracelet.

3. The reversible panel bracelet with inserted two sided panels according to claim 1 wherein open panel holding frames are formed of elastic material and wherein the bracelet is configured to be flipped in its entirety.

4. The reversible panel bracelet with inserted two sided panels according to claim 1 wherein at least one of the panels is formed of two separate facing halves coupled together.

5. The reversible panel bracelet with inserted two sided panels according to claim 1 wherein at least one of the panels is designed by the user's themselves in an on-line panel creation system.

6. The reversible panel bracelet with inserted two sided panels according to claim 1 wherein the panels include at least one of a functioning watch, a key-holding unit, an electronic device, a sports trading card, and a convertible toy.

7. A panel bracelet comprising an elastomeric body having two rectangular panel holding frames, wherein each frame is designed to hold a panel therein wherein each panel holding frame is i) generally “C” shaped in cross section to receive and retain one of the panels therein and which are press fit into the frame, or ii) includes a retaining bead that is received within a matching groove in the associated panel to receive and retain one of the panels therein and which are press fit into the frame, and a plurality of panels associated with the panel bracelet and removeably secured within the rectangular panel holding frames.

8. The panel bracelet with inserted panels according to claim 7 wherein the elastomeric body of the bracelet is formed clear or semitransparent.

9. The panel bracelet with inserted panels according to claim 8 wherein the panel holding frames of the clear or semi-transparent body have a backing on one side, such that the reverse side of the panel will be seen through the clear or semi-transparent back.

10. The panel bracelet with inserted panels according to claim 7 wherein at least one panel is associated with a panel cover having an insert window in which the panel is viewable through the window.

11. The panel bracelet with inserted panels according to claim 10 wherein the panel cover of the at least one panel snaps onto the body of bracelet.

12. The panel bracelet with inserted panels according to claim 10 wherein the cover of the at least one panel and the body of the bracelet combine to sandwich the insert there between for securing of the insert.

13. The panel bracelet with inserted panels according to claim 7 wherein at least one panel includes electronic components.

14. The panel bracelet with inserted panels according to claim 7 wherein at least one panel includes a watch.

15. The panel bracelet with inserted panels according to claim 7 wherein at least one panel is in the form of a collectable sports related element.

16. The panel bracelet with inserted panels according to claim 7 wherein at least one panel includes a USB key.

17. The panel bracelet with inserted panels according to claim 7 wherein at least one panel includes biometric sensors.

18. The panel bracelet with inserted panels according to claim 17 wherein at least one panel includes a user identifying barcode.

19. The panel bracelet with inserted panels according to claim 7 wherein at least one panel includes one of a lighter and a series of tools folded into a panel.

20. The panel bracelet with inserted panels according to claim 7 wherein at least one panel includes a pump spray container
